(19) United States
(12) Patent Application Publication
(10) Pub. No.: US 2009/0296380 A1
(43) Pub. Date: Dec. 3, 2009

(54) KIND OF LIGHTING SET FOR THE FLOOR JACK

(75) Inventors: Min Shen, Jiangsu (CN); Youyuan Chen, Jiangsu (CN)

Correspondence Address: LADAS & PARRY, 5670 WILSHIRE BOULEVARD, SUITE 2100, LOS ANGELES, CA, 90036-5679, US

(73) Assignee: CHANGSHU TONGRUN AUTO ACCESSORY CO., LTD., Jiangsu (CN)

(21) Appl. No.: 12/368,704

(22) Filed: Feb. 10, 2009

(30) Foreign Application Priority Data
Jun. 2, 2008 (CN) 200810122584.4

(51) Int. Cl. F21L 4/00; B66F 3/00

(52) U.S. Cl. 362/185; 254/11

(57) ABSTRACT

A type of illuminating device used to horizontal jack, of which, the middle part of the axial hole of tray axle (1) is provided with insulating filling (6) and transparent polymethylmethacrylate sheet (10); the positioning set (11) under the polymethylmethacrylate sheet (10) is equipped with LED illuminating bulb (13) and relevant circuit elements to form the loop of the illuminating circuit available for control of switch-on and switch-off; the illuminating device of this invention is integrated on the central part of the tray of horizontal jack, which makes full use of the space of tray axial hole to ensure the reliable operation of illuminating elements and relevant circuits with its sound sealing performance for the purpose of improving the poor illumination and solving the problem with maintenance of vehicles and lifting of heavy goods at night.

### TECHNICAL FIELD

This invention involves the illuminating light for horizontal jack, especially a type of illuminating device installed at the tray part of the horizontal jack.

### BACKGROUND TECHNOLOGY

Various existing horizontal jack are normally provided with illuminating lights; although there is no problem with the utilization of horizontal jack at daytime or under the sound illuminating conditions, this is really inconvenient for operators to manipulate the jack with one hand with the other hand holding the electric torch for irradiation when lifting vehicles or heavy goods in cloudy days or at the time when the illumination is not available or inadequate. Moreover, it is not safe to lift vehicles or heavy goods with jack when the illuminating device is not available.

### SUMMARY OF INVENTION

This invention aims to overcome existing technical defects to provide a type of illuminating structure installed at the center of the tray parts of horizontal jack, so as to enable operators to use horizontal jack to repair vehicles and lift heavy goods safely and conveniently.

The aforesaid purposes of this invention are realized by the following technical proposal: a type of illuminating device used to the horizontal jack, including tray, tray axle, bracket axle, illuminating circuit and elements, has the following features: external circle of tray axle is in clearance fit with bracket hole and tray hole; cone axle of the tray axle aims to realize the axial positioning with the inner cone hole of the tray; the middle space of axial hole of tray axle is filled with insulating filling; the upper part of the axial hole of tray axle is provided with a small step hole forming inner step end of the same axle and hole, which is provided with transparent and visible polymethylmethacrylate sheet; the positioning set under the polymethylmethacrylate sheet is used to provide space for installation of LED illuminating light bead; light foot of each LED light bead of the same pole is inserted into the positioning hole of insulating positioning plate uniformly distributed trochoid C of small circle for conductive connection with metal reed; another light foot of the same pole is inserted into the positioning hole of insulating positioning plate uniformly distributed trochoid D of small circle for conductive connection with metal conductive sleeve; metal conductive sleeve is in conductive connection with inner hole wall of tray axle; the metal reed extends to the positive pole of the button cell module; the button cell module is inserted into the hole of insulating positioning sleeve; the lower part of the tray axle is in screw pair connection with the inner screw of the holder of the button switch via the tightening washer and external screw; the inner step end of the switch holder of the same axle and hole is equipped with flexible seal cover which can play sound sealing, damp-proof and dustproof role under the action of axial force produced after the aforesaid screw pair is tightened.

As compared with existing technologies, this invention has the following favorable effects: the illuminating device installed at the tray center of the horizontal jack as described in this proposal makes full use of the space of tray axle and hole to ensure the reliable operation of illuminating elements and circuit with its sound sealing performance for the purpose of solving the problem with the maintenance of vehicles or lifting of heavy goods at night or in case of inadequate illumination effectively; it is applicable to connect metal electric bridge with cathode contact of the cell and conductive spring at the left upper corner by pressing the switch button on the lower end of the flexible seal cover; it is also applicable to electrify the contact and conductive panel at the right upper corner to further electrify each LED light foot uniformly distributed on the big circle trochoid D via holder of the button switch, tray axle and metal conductive sleeve.

### ILLUMINATION OF ATTACHED DRAWINGS

Illumination of attached drawings for empirical examples:

FIG. 1: structural diagram for horizontal jack as described in this proposal

FIG. 2: local enlarged FIG. I corresponding to FIG. 1 of this proposal

FIG. 3: A-A cutway view enlarged on FIG. 2 of this proposal

FIG. 4: B-B cutway view enlarged on FIG. 2 of this proposal

Designations of FIG. 2, 3 and 4 are stated as follows:

1 tray axle; 2 bracket hole; 3 tray hole; 4 cone axle; 5 inner cone hole of tray; 6 insulating filling; 7 limit hole; 8 small step hole; 9 inner step end of the same axle and hole; 10 transparent and visible polymethylmethacrylate sheet; 11 positioning sleeve; 12 light bead space; 13 illuminating bead; 14 light foot of the same pole; 15 insulating positioning plate; 16 metal reed; 17 light foot of the same pole; 18 metal conductive sleeve; 19 insulating sleeve; 20 button cell module; 21 cell anode; 22 insulating positioning sleeve; 23 tightening washer; 24 button switch; 25 holder; 26 inner step end of the same axle and hole; 27 flexible seal sleeve; 28 switch button; 29 metal electric bridge plate; 30 cathode contact of the cell; 31 conductive spring; 32 contact; 33 conductive plate; 34 insulating sleeve; 35 positioning sleeve; 36 bracket pin; 37 bracket

### SPECIFIC IMPLEMENTATION MODES

Further description of this invention in combination with attached drawings for empirical examples is helpful to the understanding of technical contents and effects of this invention.

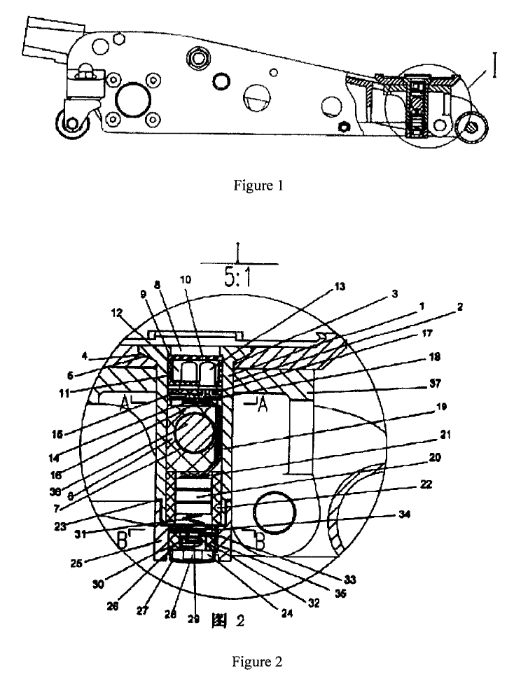

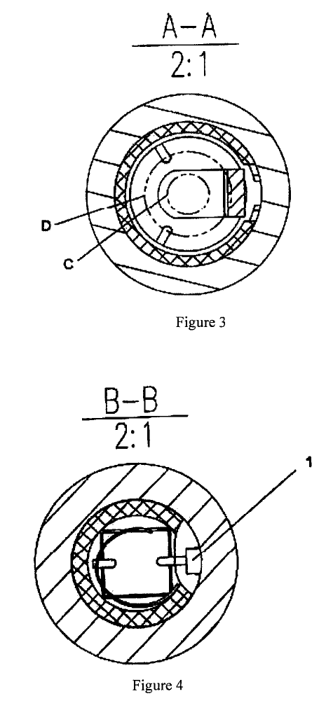

As indicated on FIG. 1, this illuminating device is applied to the center of front tray of horizontal jack. When the jack is used in the environment of inadequate illumination, it is only need to switch on the button switch to let the light in the light bead space to penetrate through the transparent and visible polymethylmethacrylate sheet 10 to illuminate the lifting area.

As indicated on FIG. 2, 3 and 4, the middle part of insulating filling is provided with a limit hole 7 for serial connection of bracket 37 and bracket pin 36, of which, the space reserved on the left side aims to facilitate metal reed 16 wrapped with insulating sleeve 19 to span both upper and lower area for the purpose of leading anode 21 of cell module to the light foot 14 of the same pole; cathode of the cell module aims to lead the circuit to light foot 17 of the same pole of LED illuminating bead 13 via the conductive spring 31, cathode contact 30, metal electric bridge plate 29 of button switch 24 switched on, contact 32, conductive plate 33, holder 25, tray axle 1 and metal conductive plate 15; positioning sleeve 11, insulating positioning plate 15, insulating positioning sleeve 22, insulating sleeve 34 and positioning sleeve 35 without exception play the role of area limit and restriction of elements.

This invention is applied as follows: in case of inadequate illumination, it is applicable to lift up tray of the jack appropriately prior to use; manually press the switch button 28 at the center of flexible seal sleeve 27 to make the bridge plate 29 in the switch move upwards so as to lead two light feet of LED light bead in parallel connection to the anode and cathode of the cell module respectively to form integral loop of closed circuit for the purpose of lighting LED light bead. The path of electrified circuit is stated as follows: the anode 21 of button cell 20 in the insulating positioning sleeve 22 is led to light foot 14 of the same pole of LED light bead via the metal reed 16 wrapped with insulating sleeve 19; another light foot of the same pole 17 of each light bead is connected to the cathode of cell module via the electrified tray axle 1 of metal conductive sleeve 18, screw connected holder 25, conductive plate 33, contact 32, metal bridge plate 29, cathode contact 30 of the cell and conductive spring 31 to penetrate through the whole circuit loop; on the contrary, it is also applicable to press switch button 28 again to make metal bridge plate 29 move downwards; the light would be extinguished when aforesaid circuit loop is cut off on both ends of the metal bridge plate 29.

1. A type of illuminating device used to the horizontal jack, including tray, tray axle, bracket axle, illuminating circuit and elements, has the following features: external circle of tray axle (1) is in clearance fit with bracket hole (2) and tray hole (3); cone axle (4) of the tray axle (1) aims to realize the axial positioning with the inner cone hole of the tray; the middle space of axial hole of tray axle is filled with insulating filling (6); the upper part of the axial hole of tray axle is provided with a small step hole forming inner step end (9) of the same axle and hole, which is provided with transparent and visible polymethylmethacrylate sheet (10); the positioning set (11) under the polymethylmethacrylate sheet (10) is used to provide space (12) for installation of LED illuminating light bead; light foot (14) of each LED light bead of the same pole is inserted into the positioning hole of insulating positioning plate (15) uniformly distributed trochoid C of small circle for conductive connection with metal reed (16); another light foot (17) of the same pole is inserted into the positioning hole of insulating positioning plate (15) uniformly distributed trochoid D of small circle for conductive connection with metal conductive sleeve (18); metal conductive sleeve (18) is in conductive connection with inner hole wall of tray axle (1); the metal reed (16) extends to the positive pole (21) of the button cell module; the button cell module (20) is inserted into the hole of insulating positioning sleeve (22); the lower part of the tray axle (1) is in screw pair connection with the inner screw of the holder (25) of the button switch via the tightening washer (23) and external screw; the button switch (24) used to control the switch-on and switch-off of the loop of illuminating circuit is provided inside the switch holder (25).

2. According to claim 1, the illuminating device used to the horizontal jack has the following features: the position limit hole (7) used for connection with bracket pin (36) is provided inside the insulating filling (6).

3. According to claim 1, the illuminating device used to the horizontal jack also has the following features: the external part of middle section of metal reed (16) is wrapped with insulating cover (19).

4. According to claim 1, the illuminating device used to the horizontal jack also has the following features: the inner step (26) end of the switch holder (25) on the same axle and hole is provided with flexible seal sleeve (27).

5. According to claim 1, the illuminating device used to the horizontal jack also has the following features: the negative pole of the button cell module (20) is in conductive connection with conductive spring (31) and negative contact (30) of the cell; contact (32) is led to the tray axle (1) through conductive connection with conductive panel (33) and holder (25) of the button switch (24).

6. According to claim 1, the illuminating device used to the horizontal jack also has the following features: the transparent and visible polymethylmethacrylate sheet (10) and the inner step end (9) of the same axle and hole are sealed with neutral silicone weather proofing sealant of single constituent.
